(19) United States
(12) Patent Application Publication
(10) Pub. No.: US 2007/0005527 A1
(43) Pub. Date: Jan. 4, 2007

(54) Model reduction system and method for component lifing

(75) Inventor: Girija Parthasarathy, Maple Grove, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/240,181

(22) Filed: Sep. 29, 2005

Related U.S. Application Data
(60) Provisional application No. 60/688,088, filed on Jun. 6, 2005.

(51) Int. Cl. G06N 3/02

(52) U.S. Cl. 706/15

(57) ABSTRACT

A model reduction system and method that facilitates improved component lifing is provided. The model reduction system and method uses a range of operating conditions and system identification techniques to reduce a physics-based component model. Specifically, system identification techniques are used to create a reduced component model. The reduced component model facilitates the use of measured operating conditions in calculating component lifing. Specifically, the reduced component lifing model provides the ability to predict selected parameters of interest at specified critical locations without requiring excessive computations. Thus, the reduced component model can be used with actual measured operating conditions to calculate component lifing over the life of the component. Thus, the reduced component lifing model facilitates improved component lifing calculation.

This application claims the benefit of U.S. Provisional Application No. 60/688,088, filed Jun. 6, 2005.

### FIELD OF THE INVENTION

This invention generally relates to diagnostic systems, and more specifically relates to component lifing.

### BACKGROUND OF THE INVENTION

Engines are a particularly critical part of modern aircraft, and the reliability of engines in the aircraft is thus of critical importance. One technique for improving the reliability of engines and other complex systems is to estimate the operational lifetime of critical components in the system and repair or replace those components before those components have an unacceptable probability of failure.

The process of estimating the operational lifetime of a component is generally referred to as component lifing. The techniques used for component lifing generally must be specifically tailored to the component, the operational conditions of the component, and the most common failure modes for the component. For example, in rotating components, such as turbine disks in turbine engines, the most common failure mode for engine rotating components is material fatigue. Material fatigue is generally caused by the stresses and temperatures resulting from start-stop cycles in the turbine engine. Component lifing of rotating components thus generally involves calculating the number of start-stop cycles that the component can experience without an unacceptable probability of failure from material fatigue.

In the past this type of component lifing was typically calculated during the design phase of the component. Specifically, during the design phase a detailed calculation of the stresses and temperatures of the component are made for a typical “standard flight”. These calculations are based on the material properties and failure models of the components. One limitation in calculating component lifing using a standard flight is the inability to take into account the actual operating conditions the component experiences. Thus, in cases where the actual operating conditions of flights are significantly different than the standard flight used to calculate component lifing, the calculation of the component lifing can be unacceptably inaccurate. Inaccuracy in the component lifing calculation can cause the component to be repaired or replaced well before the lifetime of the component is actually used up. Alternatively, inaccuracy in component lifing can allow the component to fail before it is replaced. In either case, the inaccuracy in component lifing is highly undesirable.

### BRIEF SUMMARY OF THE INVENTION

The present invention provides a model reduction system and method that facilitates improved component lifing. The model reduction system and method uses a range of operating conditions and system identification techniques to reduce a physics-based component model. Specifically, system identification techniques are used to create a reduced component model. The reduced component model facilitates the use of measured operating conditions in calculating component lifing. Specifically, the reduced component lifing model provides the ability to predict selected parameters of interest at specified critical locations without requiring excessive computations. Thus, the reduced component model can be used with actual measured operating conditions to calculate component lifing over the life of the component. Thus, the reduced component lifing model facilitates improved component lifing calculation.

The model reduction system and method uses system identification to reduce the physics-based component model. In system identification, a system's observed input and output data are used to create a dynamic model of the system. In the current invention, the inputs and outputs of a physics-based component model are observed and system identification is used to create a dynamic model of the physics-based component model. Specifically, a range of operating conditions is inputted into the physics-based component model. The resulting outputs of the physics-based component model are observed and used create the reduced component model.

In one embodiment, the system identification technique uses a dynamic neural network to reduce the model. The neural network learns the non-linear mapping between inputs and outputs in the physics-based component model. From this mapping, the neural network creates the reduced component model. In another embodiment, a dynamic analysis of the physics-based component model is performed. For example, by applying a step function and measuring the impulse response of the physics-based component model. In both cases, system identification is used to create a reduced component model.

When the reduced component model is created it provides a mechanism for dynamic lifing calculation. Specifically, the reduced component model is created to be focused on specific critical operational parameters of a component at specific critical locations. The reduced component model is thus less computationally intensive then the original physics based model, while still preserving the dynamic information in the original model. As such, the reduced component model facilitates repeated recalculation of lifing based on actual measured operating conditions over the life of the component. Thus, the life of the component can be effectively updated based on actual operating conditions of the component.

The foregoing and other objects, features and advantages of the invention will be apparent from the following more particular description of a preferred embodiment of the invention, as illustrated in the accompanying drawings.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of model reduction system in accordance with an embodiment of the invention;

FIG. 2 is a schematic view of a lifing system in accordance with an embodiment of the invention;

FIG. 3 is a graphical view illustrating an exemplary step input, step response of one critical node temperature and the corresponding impulse response;

FIGS. 4, 5 and 6 a graphically views illustrating exemplary results for a turbine engine;

FIG. 7 is a graphical view of exemplary critical node stress prediction; and

FIG. 8 is a schematic view of a computer system that includes a transient fault detection program.

### DETAILED DESCRIPTION OF THE INVENTION

The present invention provides a model reduction system and method that facilitates improved component lifing. The model reduction system and method uses a range of operating conditions and system identification techniques to reduce a physics-based component model. Specifically, system identification techniques are used to create a reduced component model. The reduced component model facilitates the use of measured operating conditions in calculating component lifing. Specifically, the reduced component lifing model provides the ability to predict selected parameters of interest at specified critical locations without requiring excessive computations. Thus, the reduced component model can be used with actual measured operating conditions to calculate component lifing over the life of the component. Thus, the reduced component lifing model facilitates improved component lifing calculation.

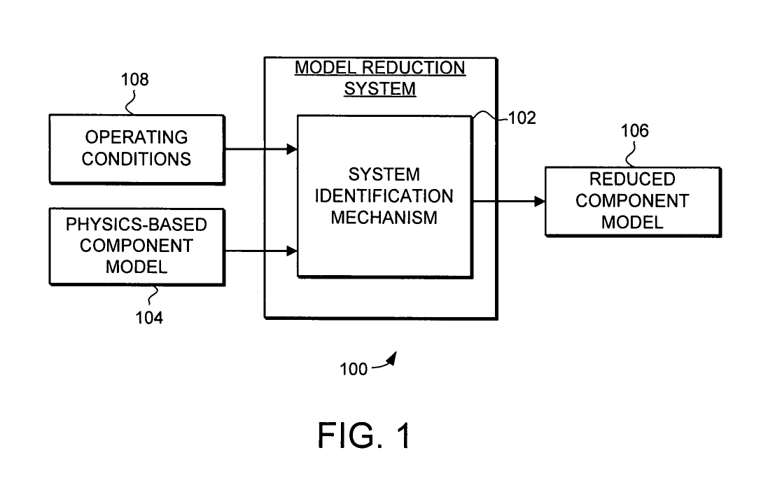

Turning now to FIG. 1, an exemplary model reduction system 100 is illustrated schematically. The model reduction system 100 includes a system identification mechanism 102. The model reduction system 100 receives a physics-based component model 104, and operating conditions 108, and uses the system identification mechanism 102 to create a reduced component model 106. The system identification mechanism 102 uses system identification to reduce the physics-based component model 104. In system identification, a system's observed input and output data are used to create a dynamic model of the system. Thus, in system 100 the operating conditions 108 comprises a range of input data applied to the physics based component model 104. The system identification mechanism 102 observes the resulting outputs of the physics based component model 104 and uses the inputs, outputs and physics-based component model 104 to create a dynamic, reduced component model 106.

Several different types of physics based component model 104 can be used to create the reduced component model 106. For example, the reduced component model 106 can be created from finite-element models, such as thermal or stress models used to model temperature or stress in rotating components. In a physics-based, finite-element model the component is discretized into a finite number of parts or elements. The partial differential equations describing the behavior of stress or temperature are approximately solved for the finite elements of the components, thus giving us the distribution of temperature and/or stress of the component. While such a finite-element model can be effectively used for lifing calculations during component design, they are typically too computationally intensive to be repeatedly used to recalculate lifing based on actual measured operating conditions over the life of the component. The model reduction system 100 overcomes this limitation by creating the reduced component lifing model 106.

In one embodiment, the system identification mechanism 102 uses a dynamic neural network to create the reduced component model 106. In this technique, the neural network learns the non-linear mapping between inputs and outputs in the physics-based component model 104. From this mapping, the neural network creates the reduced component model 106. In another embodiment, a dynamic analysis of the physics-based component model 104 is performed. For example, by applying a step function and measuring the impulse response of the physics-based component model 104. In both cases, a system identification technique is used to create a reduced component model 106.

When the reduced component model 102 is created it provides a mechanism for dynamic lifing calculation. The reduced component model 102 is created to be focused on specific critical component parameters of a component at specific critical locations. For example, the reduced component model can be created to calculate the temperatures and stresses on a component at only a few select locations on the component. The reduced component model 102 is thus less computationally intensive than the original physics based model, while still preserving the dynamic information in the original model. As such, the reduced component model 102 facilitates repeated recalculation of lifing based on actual measured operating conditions over the life of the component. Thus, the life of the component can be effectively updated based on actual operating conditions of the component.

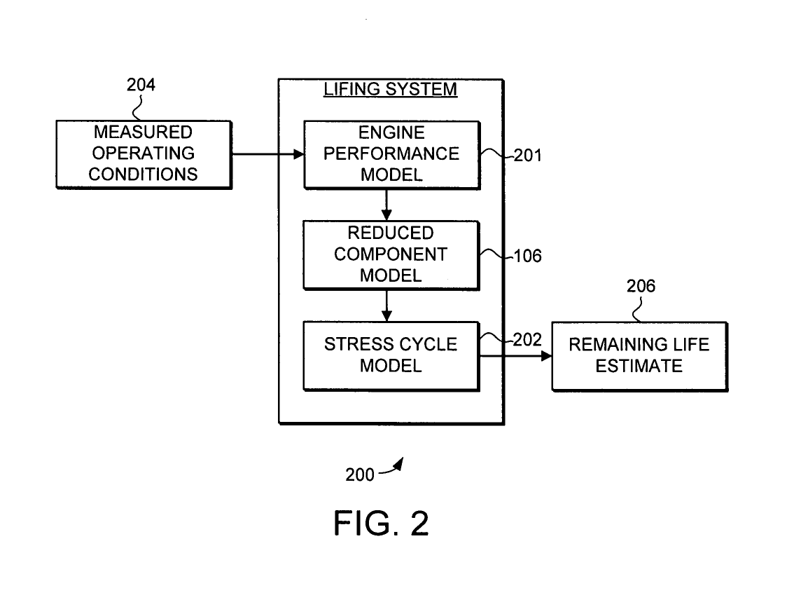

Turning now to FIG. 2, a lifing system 200 is illustrated schematically. The lifing system 200 uses the reduced component model 106, along with an engine performance model 201 and a stress cycle model 202 to effectively and accurately calculate a remaining life estimate 206 for the component of interest.

The lifing system 200 processes measured operating conditions (such as engine speed, ambient temperature, altitude, etc) with the engine performance model 201. The engine performance model 201 comprises a steady state thermodynamic model of the engine that is used to compute operating parameters of the engine based on operating conditions. Thus, given the measured operating conditions, the engine performance model 201 computes various performance parameters of the engine. For example, given ambient conditions, mach number, altitude and other measurements the engine performance model 201 can calculate engine speeds, engine gas temperatures, pressures and flows at specific locations within the engine (such as pressures and flows at the axial compressor outlet and high pressure turbine inlet).

The outputs of the engine performance model 201 are passed to the reduced component model 106. In response, the reduced component model 106 calculates various component parameters at critical locations on the component. For example, the reduced component model 106 can be created to calculate temperatures and stresses at critical locations on a rotating component, such as likely failure locations on a turbine engine disk. Thus, the reduced component model 106 receives the outputs of the engine performance model 201 and calculates the resulting component parameters such as temperatures and stresses at defined critical locations.

The calculated component parameters are passed to the stress cycle model 202. In general, the stress cycle model 202 comprises a model for counting the stress cycles caused by the repetitive loading of a component. For example, the stress cycle model 202 can be implemented to calculate the repetitive loading of a component during takeoff and landings, heating and cooling off. Thus, the stress cycle model 202 provides a mechanism for counting the number of cycles that a component undergoes and thus how many cycles remain in the estimated life of the component. The stress cycle model 202 thus receives the component parameters from the reduced component model 106 and calculates the remaining life estimate of the component.

It should be noted that because the reduced component model 106 is focused on critical operational parameters of the component at selected critical locations, it can be used to estimate the life of the component with greatly reduced computational requirements. Thus, the lifing system 200 is able to use the reduced component model 106 to calculate the remaining life based on actual operating conditions of the component. Over the life of the component, as new measured operating conditions 204 are taken, they can be used to repeatedly update the calculation of the remaining life. Thus, the lifing system 200 can more accurately calculate the remaining life of a component.

The model reduction system 100 and lifing system 200 can be used to calculate remaining life of a variety of different types of components. For example, they can be used to calculate the remaining life in components that are subject to great heat and stress during high speed rotation. As one specific example, they can be used to calculate the remaining life in turbine engine components, such as turbine engine disks.

Furthermore, while the system has applied and demonstrated for rotating component lifing, this approach of reducing a detailed model (e.g. finite element, finite volume or finite difference) to estimate certain parameters, can be used in sensing, controls or diagnostics and prognostics and other applications.

As described above, several different types of system identification techniques can be used to create a reduced component model from the physics-based model. In one embodiment, dynamic neural network is used to create the reduced component model. Specifically, a dynamic neural-networks approach for system identification can be used for prediction of the time-dependent behavior of temperatures and stresses at critical locations even for systems that are highly non-linear. In this technique, the neural network learns the non-linear mapping between inputs and outputs in the physics-based component model. From this mapping, the neural network creates the reduced component model.

In general, neural networks are data processing systems that are not explicitly programmed. Instead, neural networks are trained through exposure to real-time or historical data. Neural networks are characterized by powerful pattern matching and predictive capabilities in which input variables interact heavily. Through training, neural networks learn the underlying relationships among the input and output variables, and form generalizations that are capable of representing any nonlinear function. As such, neural networks are a powerful technology for nonlinear, complex classification problems.

A neural network can be used to create the reduced component model by training the neural network to learn the mapping between inputs and outputs in the original physics-based model, using a set of observations. In general, a neural network includes various nodes, commonly arranged in layers. Training a neural network involves assigning various weights to the nodes. Various different techniques can be used for training. As one example, in order to model non-linear dynamics of the system a neural networks based system identification toolbox by Nørgaard (Neural Networks for Modeling and Control of Dynamic Systems, by Magnus Nørgaard, O. Ravn, N. K. Poulsen, and L. K. Hansen, Springer-Verlag) can be used. This toolbox has six different model structures, several of which can be used for system identification.

In a dynamic neural network, several past values of the input quantities to the system, such as rpm or gas temperature, are used as actual inputs to the neural network model. This gives the dynamic neural network the ability to capture system dynamics. In contrast with other applications of neural networks, in component lifing it is not typically possible to get actual outputs (e.g., stress or temperature at a particular critical location on a component) during real operation. These systems are instead limited to using data that can be calculated by a performance model from a limited number and type of sensors as inputs to the system. For example, they are limited to using performance model outputs such as rpm, gas temperature, and gas flow. It should be noted that since the neural network model is built from the observations obtained from other detailed models (e.g., the finite element thermal and stress models), there is also typically no measurement noise to model.

In these systems one effective model technique in the Nørgaard toolbox for training the neural network is the NNARX (Neural Networks AutoRegressive, eXternal input) model structure, as system outputs from finite element model simulation data sets are available. The inputs or regressors for the neural networks model can be past inputs to the system, and also past outputs. For example, the NNARX model can be expressed as the regression vector and a predictor, where the regression vector Φ(t) containing the regresses is expressed as:
Φ(t)=[y(t−1/Θ) . . . y(t−na/Θ)u(t−nk) . . . u(t−nb−nk+1)]^{T} (1)
And the predictor ŷ(t/Θ) is expressed as:
ŷ(t/Θ)=g(Φ(t),Θ) (2)
Where Θ is the vector containing the weights, g is the nonlinear function realized by the neural network, y is the system output, u the system inputs, t is time, and na, nb and nk are the number of past outputs, number of past inputs and time delay respectively.

However, for use in an online life computing system, the NNOE (Neural Networks Output Error) model structure can be used, since system outputs are not measured. In this embodiment, the past system outputs are replaced by past system output predictions. For example, the NNOE model can be expressed as the regression vector and a predictor, where the regression vector Φ(t) containing the regresses is expressed as:
Φ(t)=[ŷ(t−1/Θ) . . . ŷ(t−na/Θ)u(t−nk) . . . u(t−nb−nk+1)]^{T} (3)
And the predictor ŷ(t/Θ) is expressed as:
ŷ(t/Θ)=g(Φ(t),Θ) (4)

As one specific example, the dynamic neural network system identification method can be applied to predicting temperatures and stresses at critical locations of turbines and compressors for an aircraft power thermal management system. In this embodiment simulation data from the finite element models for temperature and stress for a number of different missions is used for training of the neural network model. The typical inputs would be quantities that are measured in an actual system, or easily calculated, such as station temperature, flow, and pressure. The output is the critical location temperature, or stress. The model is tuned and validated using more data from simulations.

The resulting trained neural network is the reduced component model. Thus, a dynamic neural network can be used to create the reduced component model. When used in a component lifing system, the inputs to the neural network reduced component model will be fed to the neural network reduced model, and the reduced model will output either the critical location temperature or stress, which can then be used to generate a remaining life estimate of the turbine engine components.

In addition to a neural network, other types of system identification can be used to create a reduced component model from the physics-based model. For example, in another embodiment, a dynamic analysis of the physics-based component model is performed. This embodiment is generally most useful where the system is linear or nearly linear. Dynamic analysis is the characterization of the time dependent behavior of the outputs in response to changes in the inputs. Thus, the dynamic analysis can be used for linear system identification.

Several model forms can be used for dynamic analysis. For example, state space form, transform domain, frequency response or impulse response forms can be used. As one specific technique, the impulse response of a model form can be used. The impulse response of a system is its response to a unit impulse input. Specifically, a step function is applied to the physics-based model and the resulting impulse response of the physics-based component model is measured. The resulting impulse response of the physics-based component model can then be used as the basis for system identification, and thus used to create the reduced component model.

The response to a unit impulse function as an input is referred to as the impulse response, g(t). Once the impulse response of a process is known, it can be shown that the response of this process to any arbitrary input u(t) is given by the convolution integral:

$$y ( t ) = {\int }_{0}^{t} g ( s ) u ( t - s ) ⅆ s \qquad ( 5 )$$

where s is a dummy argument. For a sampled data or discrete input system, the sampled input u(k) is related to the sampled output y(k) using the discrete impulse-response function g(k):

$$y ( k ) = {\sum }_{i = 1}^{k} g ( k ) u ( k - i ) \qquad ( 6 )$$

The response of the system for arbitrary inputs can thus be obtained if the impulse response data g(k) can be obtained from well-designed experiments. The uniqueness of the impulse response model form is that no parameter estimation, or fitting data to model is typically required, because of the direct relationship between the system's transfer function and the moments of the impulse response. A simple experiment of sending a unit impulse input to the system and recording its output response should provide g(k). In practice, it is not possible to implement an input function close enough to the ideal impulse; however, the impulse response can be derived from a step input response, or from any arbitrary input function as described below.

For step data, the first derivative of the theoretical step response (response of the system to a unit step input) gives the theoretical impulse response:

$$g ( t ) = \frac{ⅆ}{ⅆ t} [ β ( t ) ] \qquad ( 7 )$$

where g(t) is the impulse response function, and β(t) is the step response data of the system. The analogous relationship for the discrete time system is
g(k)=β(k)−β(k−1) (8)
where β(k) is the step response data observed at the k^{th} time point.

For arbitrary input/output data the impulse response data is obtained from a data of arbitrary inputs and the corresponding outputs. The impulse response is obtained by writing out equation 6 for each set of input-output data, and solving them recursively. For an input array u and corresponding outputs y, the very first observed data point yields:

$$\begin{matrix}g ( 1 ) = y ( 1 ) / u ( 0 ) & ( 9 ) \\ g ( 2 ) = \frac{1}{u ( 0 )} [ y ( 2 ) - g ( 1 ) u ( 1 ) ] & ( 10 )\end{matrix}$$

and so on. In general, at the k^{th} time point g(k) can be obtained from by:

$$g ( k ) = \frac{1}{u ( 0 )} [ y ( k ) - g ( 1 ) u ( k - 1 ) - g ( 2 ) u ( k - 2 ) - … - g ( k - 1 ) u ( 1 ) ] \qquad ( 11 )$$

The above methods are applied to systems that display linear or close to linear systems. For a non-linear system, the impulse response model form for different regimes of operation can be combined to characterize the system completely. Specifically, by using the following example equations:

$$y ( k ) = {\sum }_{i = 1}^{k} g ( k ) u ( k - i ) for operating condition 1 \\ y ( l ) = {\sum }_{i = k + 1}^{l} f ( l ) u ( l - i ) for operating condition 2 \qquad ( 12 )$$

and so on, where g and f are impulse response function computed for operating conditions 1 and 2. (e.g. takeoff, descend, ground idle-taxi, etc).

It should be noted that equations (2) and (8) apply to zero initial conditions. In order to apply these equations to non-zero initial conditions, the following method is used. For each segment of the flight where a different impulse response function is used, the inputs are offset to zero initial condition using the first data point in that segment.
u=u_{actual}−uᵢₙᵢₜᵢₐₗ (9)
The output y calculated is for the input that is offset thus. The corrected output y is obtained by adding the initial y data point.

$$y = {y}_{initial} + {\sum }_{i = 1}^{k} g ( k ) u ( k - i ) \qquad ( 10 )$$

For the very first segment, the known initial output is used (this can be replaced with computed output for initial conditions based on separate steady state analysis). For subsequent flight segments, the initial condition is taken to be the same as the last data point of the previous segment.

In real operation, the time series measurement of u is used in equations 6 or 12 to obtain the time series predictions of output y (for example, the critical location temperature or stress). This can then be used to create the reduced component lifing model.

Thus, system identification can be performed using a dynamic analysis to create a reduced component model. As stated above, dynamic analysis is generally most useful where the system is linear or nearly linear. In non-linear systems the neural network approach to creating a reduced component model would generally be preferable.

A specific application of a model reduction and component lifing system will now be discussed. In this application, a dynamic analysis and system identification methods were applied first to create a reduced component model that predicts temperature at two critical reference nodes on the impeller of turbine engine.

To create the reduced component mode an impulse response technique was used. To best mimic a true step, the thermal model was excited with boundary conditions that are equivalent of taking the engine from a steady state condition of ground idle to takeoff condition. It should be noted that this is not a single input process, since operating conditions such as speed, temperatures, pressures and flow rates will change simultaneously, corresponding to changes in operating condition (ground idle and steady state). The process assumes that these entities are correlated and any change in one of them is reflected in the others. The impulse responses for the two reference node temperatures were extracted from the step responses, by applying equation 8, while considering Tg as input.

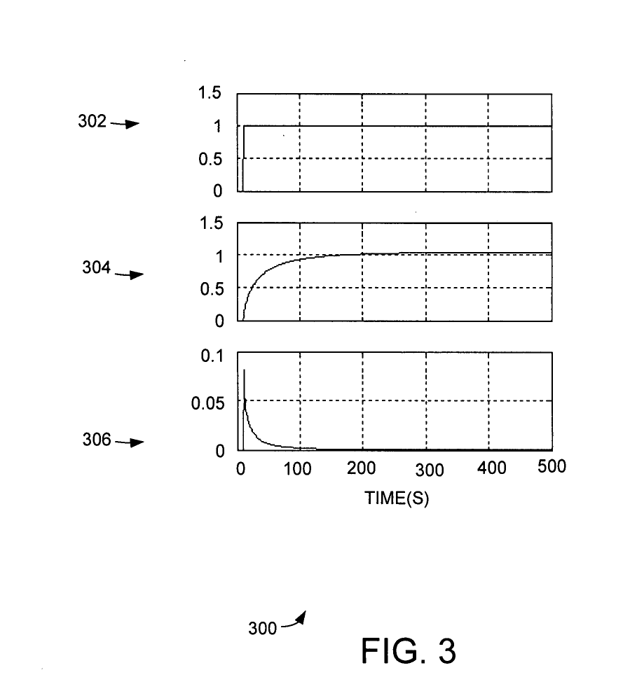

Turning now to FIG. 3, FIG. 3 includes graphs 300 that illustrate an exemplary step input (plot 302), an exemplary step response of one critical node temperature (plot 304) and the corresponding impulse response for this specific example (plot 306). In the illustrated example all quantities have been normalized for clarity. The impulse response illustrated in FIG. 3 was thus used to create a reduced component model, using the techniques described above. Sensor data from several arbitrary missions was then applied as inputs to the reduced component model, which in turn predicted critical node temperatures. The predicted temperatures obtained from the reduced model were compared with the temperatures obtained by running the full physics-based thermal model.

In some cases the identification steps of generating data, formulating a model, and validation with another set of data indicated will not be completely accurate for regimes of operation that are not close to the region of the step input experiment. To overcome this, impulse response functions can be derived for different regimes, such as engine off to ground idle, ground idle to takeoff/climb/cruise, cruise to taxi and ground idle, and idle to engine off condition. The output node temperatures for the whole mission can then be predicted by combining the different impulse responses as given in equation 12, with the corresponding inputs. As stated earlier, in one embodiment the gas temperature in the vicinity of the component was selected as the input because of better accuracy for all validation test cases.

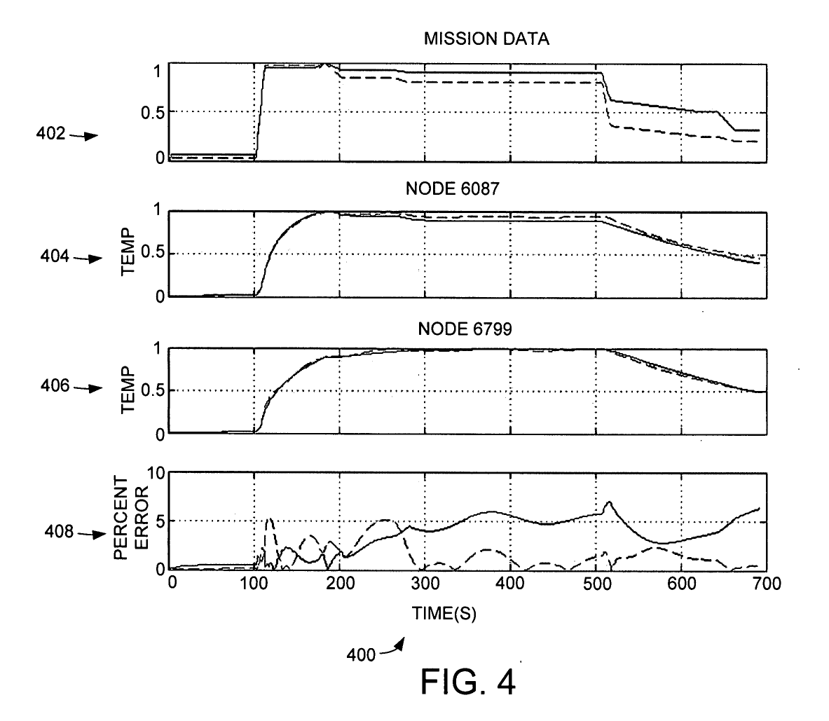

Turning now to FIGS. 4, 5 and 6, the results of an arbitrary mission are illustrated. Specifically, FIG. 4 includes graphs 400 that illustrate a mission that starts with idle, taxi, takeoff, climb, cruise and descent. The topmost plot 402 shows the normalized engine speed and station temperature T2.9 for the mission time. Station temperatures are calculated using the engine performance model, and it is assumed that the gas dynamics is very fast, and hence there is no lag between changes in engine speed and station temperatures. Plots 404 and 406 illustrated the predicted node temperature between the reduced component model (illustrated with dotted lines) and the full physics based thermal model (illustrated with solid lines) at two reference nodes 6807 and 6799. The percentage error between the reduced model and the full thermal model predictions are shown on the bottom plot 408, for the two reference nodes. The reduced model predictions for nodal temperatures match well with the full model temperatures.

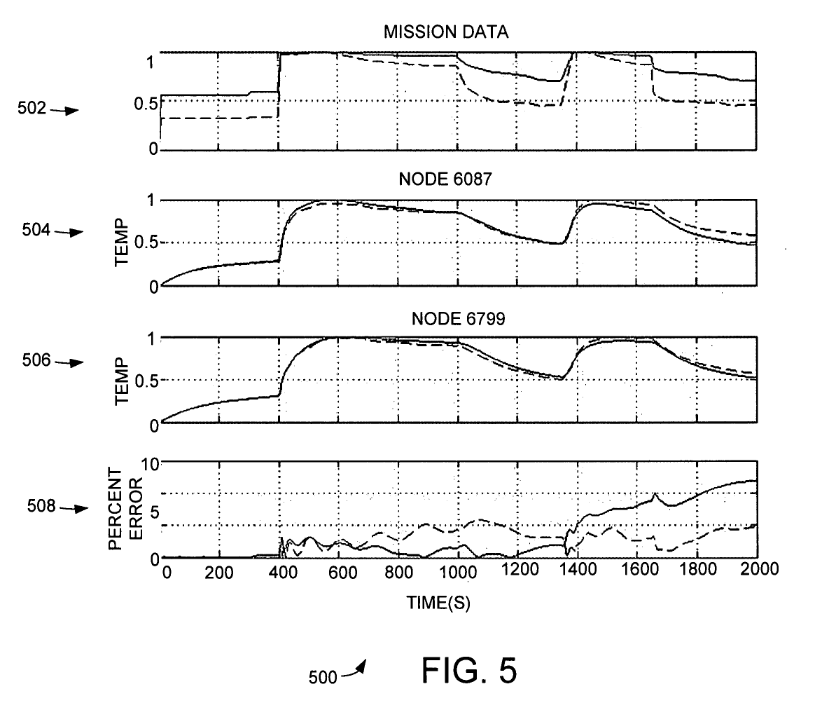

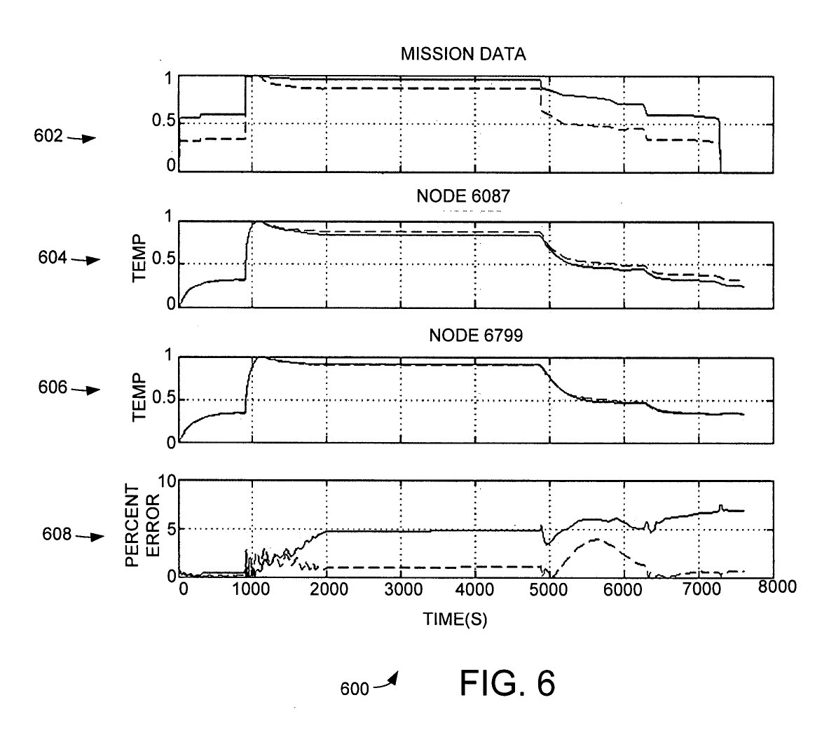

FIGS. 5 and 6 illustrate graphs 500 and 600 that illustrate a second and third mission respectively. Again, the top plots 502 and 602 illustrate normalized engine speed and temperature. Plots 504, 506, 604 and 606 again illustrated the predicted node temperature between the reduced component model (illustrated with dotted lines) and the full physics-based thermal model (illustrated with solid lines) at two reference nodes 6807 and 6799. The bottom plots bottom plots 508 and 608 illustrate the percentage error between the reduced model and the full thermal model for two reference nodes.

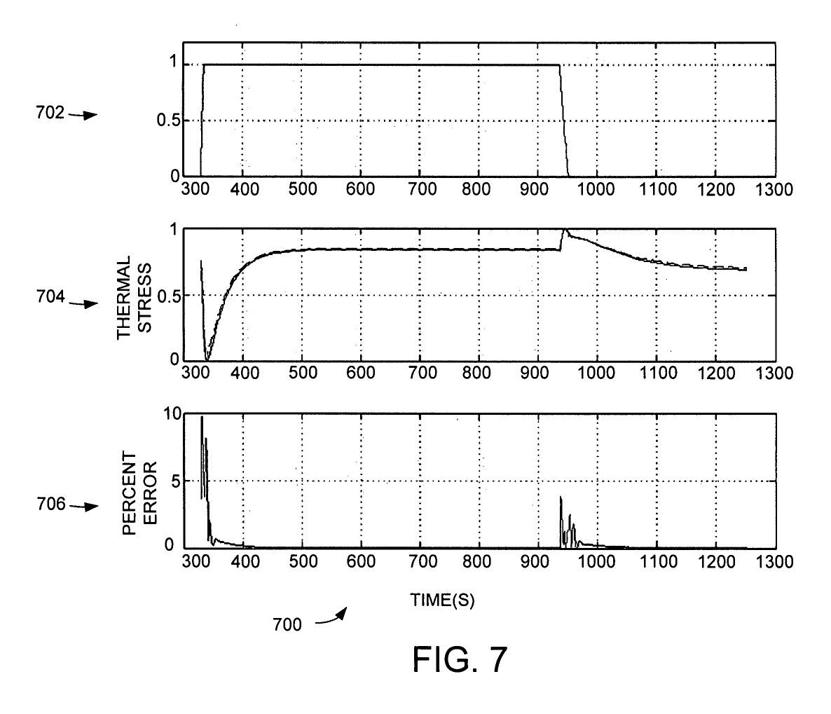

Turning now to FIG. 7, graphs 700 include three plots 702, 704, and 706 that illustrate the results for an exemplary mission with two climbs and descents. Starting with engine off condition, the engine goes through idle, taxi, takeoff, climb, cruise, descent, and another cycle of climb, cruise and descent. Again, the match between the reduced model (dotted line in graph 704) and the physics-based thermal model (solid line in graph 704) is very good. The error percentage increases during the second cycle of climb and descent. This is possibly due to the fact that enough impulse response functions were not obtained for the number of operating regimes considered, for example, the direct descent after the climb in the second cycle (with no cruise). It is of course possible to obtain the impulse response for other regimes.

There are several steps that can be taken in order to increase the accuracy of the fit. One way is to build impulse response models considering multiple inputs. This approach can be complex, since impulse responses will have to be obtained for each input, while other inputs are kept constant, or use carefully crafted experiments where all inputs are varied simultaneously. Apart from the complexity, the fact also remains that the performance model will have to generate the inputs, and physically impossible operating conditions may not yield correct results. Another way to increase accuracy is to combine impulse responses for different input variables with different weights, and using optimization techniques to compute the weights. This is a simpler, since the worst deviation from actual node temperatures is not much, and even trial and error combinations may give us an optimum model.

Although the model reduction has been presented and developed in the context of deterministic on-board life prediction, it can be equally well employed anywhere that quick and numerous computations of stresses and temperatures are needed. For example, although probabilistic life models start with a different premise, they still need to use deterministic models for calculation of temperatures and stresses at locations of interest. This procedure makes it easier and faster to make numerous computations of stresses and temperatures for different missions and operating conditions.

The model reduction concept can be applied not only for stress and temperature prediction, but also for engine diagnosis and control, and in other fields where the potential of detailed simulation models can be exploited for estimating quantities that cannot be measured. In most applications the reduced models will not replace the full numerical models during design phase analysis. However, they can be made to do double duty through model reduction and usage based life prediction. Although improvements can still be made to the accuracy of the reduced model, life prediction based on the reduced models can be more accurate than that based on start and stop cycles, since actual operating conditions will be taken into account. Therefore, advances in other areas of life prediction such as improved material models and crack growth modeling would be in a better position to be exploited for practical use.

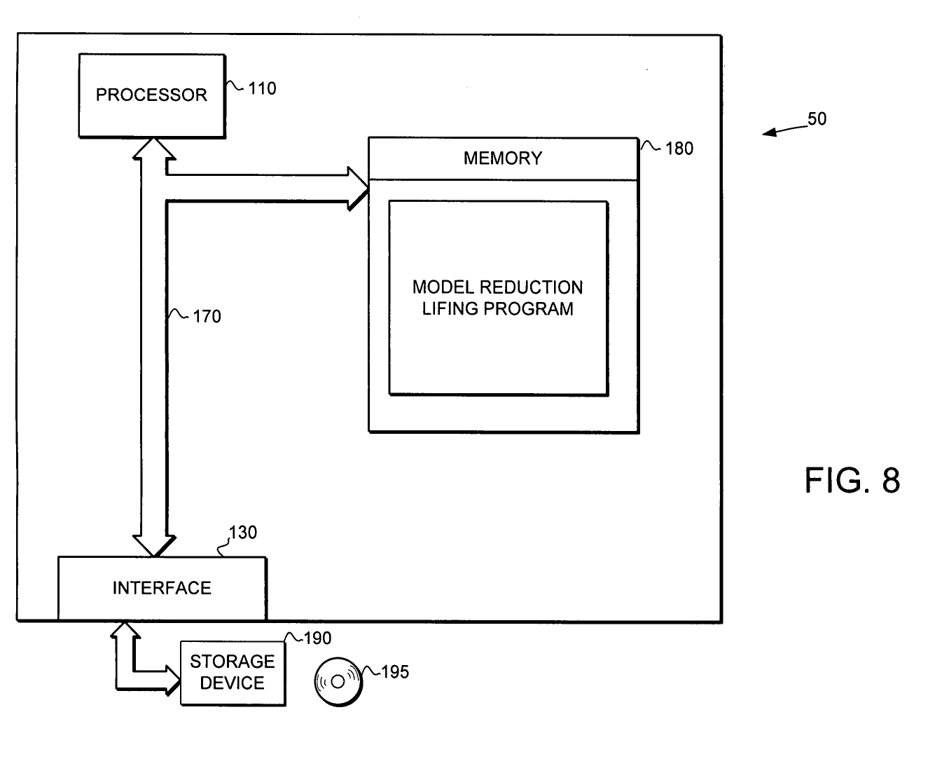

The lifing system and method can be implemented in wide variety of platforms. Turning now to FIG. 8, an exemplary computer system 50 is illustrated. Computer system 50 illustrates the general features of a computer system that can be used to implement the invention. Of course, these features are merely exemplary, and it should be understood that the invention can be implemented using different types of hardware that can include more or different features. It should be noted that the computer system can be implemented in many different environments, such as onboard an aircraft to provide onboard diagnostics, or on the ground to provide remote diagnostics. The exemplary computer system 50 includes a processor 110, an interface 130, a storage device 190, a bus 170 and a memory 180. In accordance with the preferred embodiments of the invention, the memory system 50 includes a component lifing program.

The processor 110 performs the computation and control functions of the system 50. The processor 110 may comprise any type of processor, including single integrated circuits such as a microprocessor, or may comprise any suitable number of integrated circuit devices and/or circuit boards working in cooperation to accomplish the functions of a processing unit. In addition, processor 110 may comprise multiple processors implemented on separate systems. In addition, the processor 110 may be part of an overall vehicle control, navigation, avionics, communication or diagnostic system. During operation, the processor 110 executes the programs contained within memory 180 and as such, controls the general operation of the computer system 50.

Memory 180 can be any type of suitable memory. This would include the various types of dynamic random access memory (DRAM) such as SDRAM, the various types of static RAM (SRAM), and the various types of non-volatile memory (PROM, EPROM, and flash). It should be understood that memory 180 may be a single type of memory component, or it may be composed of many different types of memory components. In addition, the memory 180 and the processor 110 may be distributed across several different computers that collectively comprise system 50. For example, a portion of memory 180 may reside on the vehicle system computer, and another portion may reside on a ground based diagnostic computer.

The bus 170 serves to transmit programs, data, status and other information or signals between the various components of system 100. The bus 170 can be any suitable physical or logical means of connecting computer systems and components. This includes, but is not limited to, direct hard-wired connections, fiber optics, infrared and wireless bus technologies.

The interface 130 allows communication to the system 50, and can be implemented using any suitable method and apparatus. It can include a network interfaces to communicate to other systems, terminal interfaces to communicate with technicians, and storage interfaces to connect to storage apparatuses such as storage device 190. Storage device 190 can be any suitable type of storage apparatus, including direct access storage devices such as hard disk drives, flash systems, floppy disk drives and optical disk drives. As shown in FIG. 8, storage device 190 can comprise a disc drive device that uses discs 195 to store data.

In accordance with the preferred embodiments of the invention, the computer system 50 includes the model reduction lifing program. Specifically during operation, the model reduction lifing program is stored in memory 180 and executed by processor 110.

As one example implementation, the model reduction lifing program can operate on data that is acquired from the system (e.g., turbine engine) and periodically uploaded to an internet website. The lifing analysis is performed by the web site and the results are returned back to the technician or other user. Thus, the system can be implemented as part of a web-based diagnostic and prognostic system.

It should also be understood that while the present invention has been described as particularly applicable to fault detection in a turbine engine, the present invention can also be applied to other mechanical systems in general and other aircraft systems in particular. Examples of the types of aircraft systems that the present invention can be applied to include environmental control systems, aircraft hydraulic systems, aircraft fuel delivery systems, lubrication systems, engine starter systems, aircraft landing systems, flight control systems and nuclear, biological, chemical (NBC) detection systems.

It should be understood that while the present invention is described here in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 195), and transmission media such as digital and analog communication links, including wireless communication links.

Thus, the present invention provides a model reduction system and method that facilitates improved component lifing. The model reduction system and method uses a range of operating conditions and system identification techniques to reduce a physics-based component model. Specifically, system identification techniques are used to create a reduced component model. The reduced component model facilitates the use of measured operating conditions in calculating component lifing. Specifically, the reduced component lifing model provides the ability to predict selected parameters of interest at specified critical locations without requiring excessive computations. Thus, the reduced component model can be used with actual measured operating conditions to calculate component lifing over the life of the component. Thus, the reduced component lifing model facilitates improved component lifing calculation.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A method of reducing a physics-based component model, the method comprising:
inputting a range of operating conditions into the physics-based component model;
measuring outputs of the physics-based component lifing model responsive to the range of operating conditions; and
creating a reduced component model from the inputted range of operating conditions and the measured outputs.

2. The method of claim 1 wherein the physics-based component model comprises a thermal model.

3. The method of claim 1 wherein the physics-based component model comprises a stress model.

4. The method of claim 1 wherein the step of creating a reduced component model from the inputted range of operating conditions and the measured outputs physics-based component model comprises using system identification.

5. The method of claim 1 wherein the step of creating a reduced component model from the inputted range of operating conditions and the measured outputs physics-based component model comprises training a neural network.

6. The method of claim 1 wherein the step of creating a reduced component model from the inputted range of operating conditions and the measured outputs physics-based component model comprises uses a step function inputted and measuring an impulse response of the physics-based component model.

7. The method of claim 1 wherein the physics-based component model comprises a model of a rotating component in a turbine engine.

8. A model reduction system for reducing a physics-based component lifing model, the model reduction system comprising:
a system identification mechanism, the system identification mechanism inputting a range of operating conditions into the physics-based component model and observing a resulting output, the system identification mechanism creating a reduced component model from the range of operating conditions and the observed resulting output.

9. The system of claim 8 wherein the physics-based component model comprises a thermal model.

10. The system of claim 8 wherein the physics-based component model comprises a stress model.

11. The system of claim 8 wherein the system identification mechanism creates the reduced component model by training a neural network.

12. The system of claim 8 wherein the system identification mechanism creates the reduced component model by using a step function inputted and measuring an impulse response of the physics-based component model.

13. The system of claim 8 wherein the physics-based component model comprises a model of a rotating component in a turbine engine.

14. A lifing system for estimating remaining life of a component, the lifing system comprising:
a reduced component model of the component, the reduced component model receiving performance parameters generated by an engine performance model from measured operating conditions of a turbine engine, the reduced component model generating operational parameters of the component at a critical location on the component from the performance parameters; and
a stress cycle model, the stress cycle model receiving the generated operational parameters of the component and estimating the remaining life the component based on the operational parameters of the component and the measured operating conditions.

15. The system of claim 14 wherein the reduced component model comprises a model of a rotating component in a turbine engine.

16. The system of claim 14 wherein the reduced component model is created from a physics-based component model.

17. The system of claim 16 wherein the physics-based component model comprises a thermal model.

18. The system of claim 16 wherein the physics-based component model comprises a stress model.

19. The system of claim 16 wherein the reduced component model is created from a physics-based component model by training a neural network.

20. The system of claim 16 wherein the reduced component model is created from a physics-based component model using a step function inputted and measuring an impulse response of the physics-based component model.

21. The system of claim 16 wherein the reduced component model is created from a physics-based component model using system identification of the physics-based component model.
